(19) United States
(12) Patent Application Publication
(10) Pub. No.: US 2026/0178315 A1
(43) Pub. Date: Jun. 25, 2026

(54) METHODS AND SYSTEMS FOR UPDATE MANAGEMENT BETWEEN EDGE DEVICES

(71) Applicant: NETRADYNE, INC., San Diego, CA (US)

(72) Inventors: Ramakrishna Kasani, Bengaluru (IN); Kishan Varma Sagi, Bengaluru (IN); Bhavani Sankar Ladi, Bengaluru (IN); Aditya M Shetty, Bengaluru (IN)

(73) Assignee: NETRADYNE, INC., San Diego, CA (US)

(21) Appl. No.: 19/427,198

(22) Filed: Dec. 19, 2025

(30) Foreign Application Priority Data
Dec. 20, 2024 (IN) 202411101435

(51) Int. Cl. G06F 8/65; H04B 17/318; H04W 84/12

(52) U.S. Cl. CPC G06F 8/65; H04B 17/318; H04W 84/12

(57) ABSTRACT

A method for distributing software updates by an edge device is disclosed. A first edge device broadcasts a beacon signal containing its current software version indicator and a service set identifier (SSID) for a wireless network it intends to establish. The first edge device then receives response signals from proximate edge devices, each indicating their respective software versions. Upon determining that at least one responding device has an older software version, the first edge device establishes the wireless network using the broadcast SSID. The first edge device then receives a request from at least one proximate device that selects it as an update source based on received signal strength indicator (RSSI) measurements. Thereafter, the first edge device transmits a software update package through the established wireless network to the requesting proximate device for version upgrading.

### CROSS-REFERENCE TO RELATED APPLICATION

The present application claims the benefit of Indian Provisional Patent Application No. 202411101435 filed on December 20, 2024, and titled, “METHODS AND SYSTEMS FOR UPDATE MANAGEMENT BETWEEN EDGE DEVICES”, the disclosure of which is expressly incorporated by reference in its entirety.

### TECHNICAL FIELD

The present disclosure is related to the field of edge computing and Internet of Things (IoT) devices, and more specifically, to distributed Over-The-Air (OTA) software updates management between edge devices.

### BACKGROUND

The information disclosed in this background section is only for the enhancement of understanding of the general background of the disclosure and should not be taken as an acknowledgement or any form of suggestion that this information forms the prior art already known to a person skilled in the art.

Edge devices, including Internet of Things (IoT) sensors, smart appliances, and mobile computing units, are increasingly deployed across a wide range of industries. Such devices commonly rely on periodic updates to maintain operational integrity, incorporate new functionalities, and support continued compliance with evolving technical standards. Over‑the‑air (OTA) update mechanisms have therefore become widely utilized for remotely delivering update packages to distributed devices without requiring physical access.

OTA update techniques typically rely on wireless communication networks, such as cellular or other broadband connections, to distribute update packages to devices operating in the field. As deployments scale, multiple devices within a given environment may require updates at overlapping times. Because device models, hardware capabilities, and existing update versions may differ, update management across heterogeneous device populations can involve substantial coordination.

In many conventional arrangements, individual devices independently retrieve update packages from a remote server via a wide‑area communication link. Such approaches may involve repeated communication sessions from multiple devices within the same deployment region. Various research and industry reports have discussed considerations relating to bandwidth usage, update timing, and overall network load in large‑scale distributed systems, indicating a need to address the complexity and resource demands of update management across edge devices.

### SUMMARY

This summary is provided to introduce a selection of concepts, in a simplified format, that are further described in the detailed description of the present disclosure. This summary is neither intended to identify key or essential inventive concepts nor is it intended for determining the scope of the present disclosure.

Certain aspects of the present disclosure are directed towards a method. The method includes broadcasting, by a first edge device, a beacon signal. The beacon signal includes a current version indicator of the first edge device and a service set identifier (SSID) corresponding to a wireless network to be established by the first edge device. The method also includes receiving, by the first edge device, response signals from one or more proximate edge devices, each response signal comprising a version indicator of a proximate edge device. The method further includes establishing, by the first edge device, a wireless network using the broadcasted SSID upon determining that one or more responding proximate edge devices possess a software version preceding a software version of the first edge device as indicated by corresponding software version indicators. Thereafter, the method includes receiving, by the first edge device, a request from at least one proximate edge device that has selected the first edge device as an update source based on received signal strength indicator (RSSI) measurements. Furthermore, the method includes transmitting, by the first edge device through the established wireless network, an update package to the at least one proximate edge device.

Certain aspects of the present disclosure are directed towards another method. The method includes detecting, by a second edge device, one or more beacon signals from one or more proximate edge devices. Each beacon signal includes a version indicator and an SSID of an available wireless network. The method also includes determining, by the second edge device, that it possesses a lowest version among the proximate edge devices. Further, the method includes measuring, by the second edge device, one or more RSSI values for each detected beacon signal. Furthermore, the method includes selecting, by the second edge device, a target master device possessing a next sequential version and exhibiting a strongest RSSI among devices with the next sequential version. Moreover, the method includes establishing, by the second edge device, a connection to the wireless network identified by the SSID. The method further includes receiving, by the second edge device, an update package corresponding to the next sequential version. Furthermore, the method includes installing, by the second edge device, the received update package to transition from its current version to the next sequential version.

Certain aspects of the present disclosure are directed towards yet another method. The method includes detecting, by a third edge device, one or more beacon signals from proximate edge devices. Each beacon signal includes a version indicator and an SSID. The method includes determining, by the third edge device, one or more first proximate edge devices with a higher version and one or more second proximate edge devices with a lower version. The method further includes evaluating, by the third edge device, a distribution topology comprising a count of the second proximate edge devices based at least on communication range, received signal strength indicators (RSSI) measurements, and version differences. The method also includes initiating a master role phase by broadcasting a beacon signal including an SSID for a wireless network to be created by the third edge device. The method further includes establishing the wireless network with the one or more second proximate edge devices. Moreover, the method includes transmitting an update package to the one or more connected second proximate edge devices.

Certain aspects of the present disclosure provide an apparatus implemented at a first edge device functioning as a master node. The apparatus includes a memory and at least one processor coupled to the memory. The at least one processor is configured to broadcast a beacon signal comprising a current version indicator, and an SSID. The at least one processor is configured to receive response signals from one or more proximate edge devices, each including a version indicator. The at least one processor is also configured to establish a wireless network using the broadcasted SSID upon determining that one or more responding proximate edge devices possess a software version preceding a software version of the first edge device as indicated by corresponding software version indicators. The at least one processor is further configured to receive a request from a proximate edge device selecting the first edge device as an update source based on RSSI measurements. Moreover, the at least one processor is configured to transmit, through the wireless network, an update package to the proximate edge device.

Certain aspects of the present disclosure provide another apparatus implemented at a second edge device functioning as a slave node. The apparatus includes a memory and at least one processor coupled to the memory. The at least one processor is configured to detect one or more beacon signals from proximate edge devices, each beacon signal comprising a version indicator and an SSID of an available wireless network. The at least one processor is further configured to determine that the second edge device possess a lowest version among the detected proximate edge devices, and to measure one or more received signal strength indicators (RSSI) for each detected beacon signal. The at least one processor is also configured to select a target master device possessing a next sequential version relative to a current version of the second edge device and exhibiting a strongest RSSI among edge devices possessing the next sequential version. Additionally, the at least one processor is configured to establish a connection to the wireless network identified by the SSID of the selected target master device, to receive through the established connection an update package corresponding to the next sequential version, and to install the received update package to transition to the next sequential version.

Certain aspects of the present disclosure provide yet another apparatus implemented at a third edge device functioning as an intermediate node. The apparatus includes a memory and at least one processor coupled to the memory. The at least one processor is configured to detect one or more beacon signals from proximate edge devices, each beacon signal comprising a version indicator and an SSID of an available wireless network. The at least one processor is further configured to determine one or more first proximate edge devices having a higher version and one or more second proximate edge devices having a lower version. The at least one processor is also configured to evaluate a distribution topology comprising a count of the second proximate edge devices, based at least on communication range, measured signal strengths, and differences in detected version levels. Moreover, the at least one processor is configured to initiate a master role phase by broadcasting a beacon signal including an SSID for a wireless network to be created by the third edge device, to establish the wireless network with the one or more second proximate edge devices, and to transmit an update package to the connected second proximate edge devices

According to certain aspects of the present disclosure, a computer program product is provided for implementation at a first edge device functioning as a master node. The computer program product includes a non-transitory computer readable medium having instructions stored thereon. The instructions are executable by one or more processors of the first edge device to cause the processors to broadcast a beacon signal comprising a current version indicator of the first edge device, and a service set identifier (SSID) corresponding to a wireless network to be established by the first edge device. The instructions further cause the processors to receive response signals from one or more proximate edge devices, each response signal comprising a version indicator of a responding proximate edge device, and to establish a wireless network using the broadcast SSID upon determining that at least one responding proximate edge device possess a preceding version relative to the first edge device. The instructions additionally cause the processors to receive a request from at least one proximate edge device that has selected the first edge device as an update source based on received signal strength indicator (RSSI) measurements, and to transmit, through the established wireless network, an update package to the proximate edge device.

According to certain aspects of the present disclosure, another computer program product is provided for implementation at a second edge device functioning as a slave node. The computer program product includes a non-transitory computer readable medium having instructions stored thereon. The instructions are executable by one or more processors of the second edge device to cause the processors to detect one or more beacon signals from proximate edge devices, each beacon signal comprising a version indicator and a Service Set Identifier (SSID) of an available wireless network. The instructions further cause the processors to determine that the second edge device possess a lowest version among the detected proximate edge devices and to measure one or more received signal strength indicators (RSSI) for each detected beacon signal. The instructions additionally cause the processors to select a target master device possessing a next sequential version relative to a current version of the second edge device and exhibiting a strongest RSSI among the proximate edge devices having the next sequential version. The instructions also cause the processors to establish a connection to the wireless network identified by the SSID of the selected target master device, to receive through that connection an update package corresponding to the next sequential version, and to install the received update package to transition from the current version to the next sequential version.

According to certain aspects of the present disclosure, yet another computer program product is provided for implementation at a third edge device functioning as an intermediate node. The computer program product includes a non-transitory computer readable medium having instructions stored thereon. The instructions are executable by one or more processors of the third edge device to cause the processors to detect one or more beacon signals from proximate edge devices, each beacon signal comprising a version indicator and a Service Set Identifier (SSID) of an available wireless network. The instructions further cause the processors to determine one or more first proximate edge devices having a higher version and one or more second proximate edge devices having a lower version. The instructions also cause the processors to evaluate a distribution topology comprising a count of the second proximate edge devices, based at least on communication range, measured signal strengths, and differences in detected version levels. The instructions additionally cause the processors to initiate a master role phase by broadcasting a beacon signal including an SSID for a wireless network to be created by the third edge device, to establish the wireless network with the one or more second proximate edge devices, and to transmit an update package to the connected second proximate edge devices.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates an environment depicting one or more edge devices in communication with a cloud server, according to an embodiment of the disclosure.

FIG. 2 illustrates a block diagram of an edge device, according to an embodiment of the disclosure.

FIG. 3 illustrates a local ad-hoc network formed by the edge devices, according to an embodiment of the disclosure.

FIG. 4 illustrates an example hierarchy for proximity‑based Over‑the‑Air (OTA) software update coordination among edge devices, according to an embodiment of the disclosure.

FIG. 5 illustrates a flowchart of a method for distributing software updates an edge device functioning as a master node, in a vehicle fleet network, in accordance with an embodiment of the present disclosure.

FIG. 6 illustrates a flowchart of a method for receiving software updates by an edge device functioning as a slave node in a vehicle fleet network, in accordance with an embodiment of the present disclosure.

FIG. 7 illustrates a flowchart of a method for cascading software updates by an edge device functioning as an intermediate node in a vehicle fleet network, in accordance with an embodiment of the present disclosure.

### DETAILED DESCRIPTION

For the purpose of promoting an understanding of the principles of the present disclosure, reference will now be made to the embodiment illustrated in the drawings and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the present disclosure. Likewise, the blocks of the embodiments may be physically combined into more complex blocks without departing from the scope of the present disclosure.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented, or a method may be practiced using any number of the aspects set forth. In addition, the scope of the disclosure is intended to cover such an apparatus or method practiced using other structure, functionality, or structure and functionality in addition to or other than the various aspects of the disclosure set forth. Any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, and system configurations, some of which are illustrated by way of example in the figures and in the following description of the preferred aspects. The detailed description and drawings are merely illustrative of the disclosure rather than limiting, the scope of the disclosure being defined by the appended claims and equivalents thereof.

Edge devices deployed in vehicular fleets and other distributed environments (e.g., telematics units, IoT sensors, cabin computing modules) frequently operate in proximate groups whose composition and connectivity vary over time. These devices typically support periodic updates to maintain feature parity, security posture, and compliance with evolving standards. In real‑world fleet operations, vehicles congregate in yards, depots, or parking areas, placing their edge devices within short‑range communication distance. This proximity presents an opportunity for localized coordination, discovery, and controlled update dissemination that complements or reduces reliance on wide‑area links.

Conventional techniques commonly treat each device as an independent endpoint for update retrieval over cellular or other wide‑area networks. When many devices in the same physical region request updates individually, repeated sessions can occur without leveraging device proximity or short‑range links. Moreover, devices within the same group may exhibit heterogeneous version states, radio link quality, and processing capabilities. Absent a local mechanism for organizing interactions and sequencing version transitions, update behavior may remain uncoordinated across the group, limiting throughput and increasing usage of wide‑area bandwidth.

The present disclosure provides a distributed, proximity‑aware update management framework enabling edge devices to discover one another, exchange version metadata, and assign roles for hierarchical dissemination. Devices broadcast beacon signals including manufacturer and version identifiers as well as wireless network parameters (e.g., SSID), allowing neighboring devices to form ad‑hoc local networks. Based on observed version states and received signal strength indicators (RSSI) measurements, devices self‑assign roles such as a super master, a master, a slave, or an intermediate node. In this hierarchy, higher‑version devices establish local connectivity and serve as controlled sources of update packages, while lower‑version devices select appropriate source devices—preferably the next sequential version with strongest RSSI for stepwise progression.

In certain embodiments, an intermediate node dynamically alternates between phases to expand distribution capacity and maintain orderly version sequencing. During a master role phase, the intermediate node creates a local wireless network identified by its SSID and transmits update packages to connected lower‑version devices. Upon completion, the intermediate node terminates the local network, enters a slave role phase, and associates with a higher‑version device to receive the next sequential update. This cyclic behavior allows cascading propagation across the cluster, with distribution topology evaluations (e.g., counts of lower‑version devices, measured RSSI, and version gaps) guiding when and how nodes assume roles to accelerate, verify, and log completion events.

In operation, a super master device can coordinate update orchestration across multiple masters and their assigned slaves, manage batch progression, and maintain reporting to back‑end services where applicable. The masters disseminate update packages to their respective groups, slaves validate and install received packages to advance versions, and intermediates expand reach by bridging version gaps while maintaining controlled association policies. Collectively, the present disclosure enables localized, role‑based update coordination that leverages proximity and short‑range communication to improve throughput, reduce wide‑area bandwidth usage, and provide structured logs of completion states for subsequent verification and audit within fleet environments.

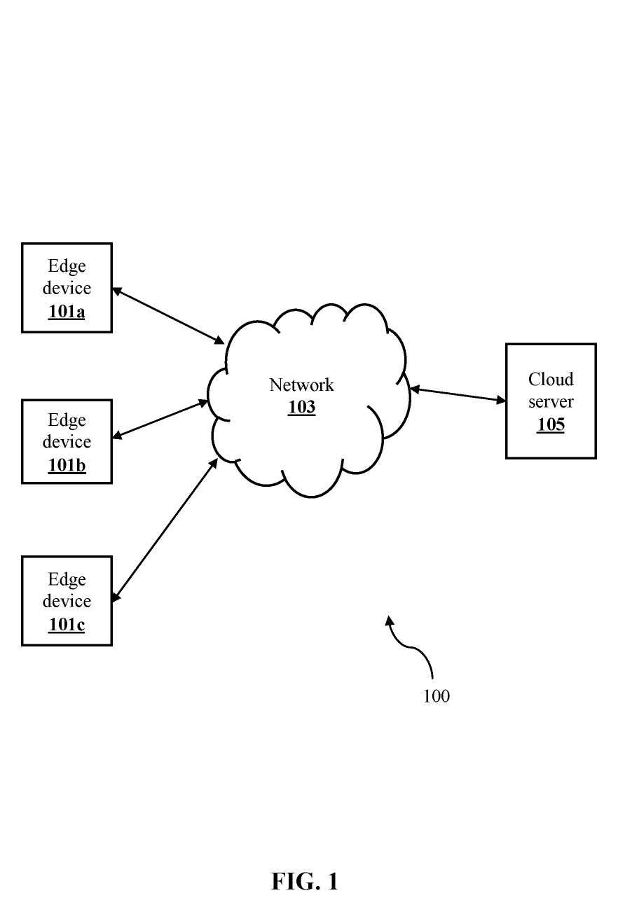

FIG. 1 illustrates an example environment 100 in which a plurality of edge devices 101a-101c communicate with a cloud server 105 for the purpose of managing Over‑the‑Air (OTA) software updates, in accordance with an embodiment of the present disclosure. As shown, the environment 100 includes multiple edge devices, namely a first edge device 101a, a second edge device 101b, and a third edge device 101c, each of which is configured to exchange software‑related information and update metadata with the cloud server 105 through a communication network 103 (also referred to as the network 103).

In an embodiment, the network 103 represents one or more communication infrastructures enabling wireless data exchange between the edge devices 101a–101c and the cloud server 105. The network 103 may include Global System for Mobile Communications (GSM), Long‑Term Evolution (LTE), Fifth‑Generation Mobile Network (5G), or other broadband wireless communication systems. In some embodiments, the network 103 may additionally include Wireless Fidelity (Wi‑Fi)‑based connectivity or short‑range wireless protocols such as Bluetooth (BT), or Bluetooth Low‑Energy (BT‑LE) for exchanging control signals or update‑related metadata under certain operating conditions.

Each of the edge devices 101a–101c includes one or more communication modules configured to establish a secure communication link with the cloud server 105 for transmitting or receiving OTA‑related data. These communication modules may support cellular interfaces such as Long‑Term Evolution (LTE) or short‑range interfaces such as Wireless Fidelity (Wi‑Fi), Near‑Field Communication (NFC), Bluetooth (BT), and Bluetooth Low‑Energy (BT‑LE). Through these interfaces, an edge device 101 periodically polls the cloud server 105 for software update availability, retrieves update manifests, transmits version identifiers, or receives update orchestration instructions.

During normal operation, each edge device 101a–101c is configured to maintain periodic communication with the cloud server 105 to exchange version status information, update eligibility rules, and configuration parameters relevant to OTA update distribution. For instance, the edge device 101 may upload a current software version identifier or capability descriptor, allowing the cloud server 105 to determine whether an update is required, deferred, or already updated. In certain embodiments, the edge device 101 may also download update packages or partial update segments directly from the cloud server 105 when network availability permits.

In scenarios where a large number of edge devices operate within a fleet, the cloud server 105 acts as a centralized authority for update management. The cloud server 105 may store update packages, maintain device‑specific update histories, and schedule OTA rollouts across the fleet. The cloud server 105 may further transmit update triggers, update configuration settings, or instructions that govern distributed update propagation among proximate edge devices, such as enabling local ad‑hoc update distribution when short‑range connectivity is detected.

The cloud server 105 provides configuration settings and software related services to the edge devices 101a-101c. The cloud server 105 may store the data received from the edge devices 101a-101c. Further, the cloud server 105 may provide alerts to a fleet operator, which may be accomplished by transmitting the alerts to a smartphone or similar device that is used by the fleet operator.

Although FIG. 1 illustrates a configuration in which the edge devices 101a–101c communicate directly with the cloud server 105 through the network 103, it will be understood that in certain embodiments, short‑range connectivity between edge devices 101a–101c may be used to offload update traffic, reduce wide‑area bandwidth usage, or enable cascading, proximity‑based update distribution as further described in subsequent figures and their respective descriptions.

Accordingly, FIG. 1 provides a high‑level view of an OTA software update environment in which multiple edge devices 101a–101c interface with the cloud server 105 over the communication network 103, enabling remote delivery, coordination, and management of software updates across a distributed deployment of devices.

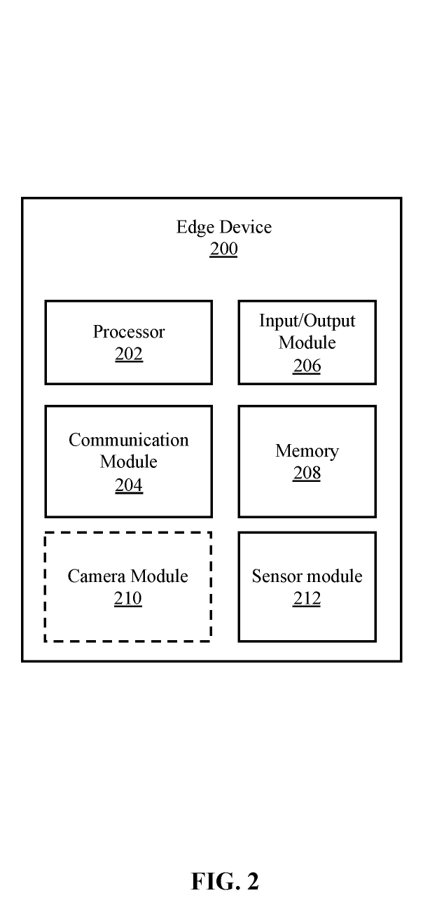

FIG. 2 shows a block diagram of the edge device 200, which is similar to the edge devices 101a, 101b, and 101a. The edge device 200 may include a processor 202, a communication module 204, an input/output (I/O) module 206, a memory 208, a camera module 210, and a sensor module 212. In some cases, the edge device 200 may not contain the camera module 210, and the camera may instead be connected externally through a wired or wireless link. The edge device 200 can use various input sensors, such as a forward‑facing camera, a driver‑facing camera, additional external cameras, inertial sensors, or vehicle data received through the On‑Board Diagnostics (OBD)‑II port, which may be accessed over Bluetooth (BT). The edge device 200 may be provided computing capability through the processor 202, which may be a standalone central processing unit (CPU) or an integrated System‑on‑a‑Chip (SoC) housing a CPU, a Graphics Processing Unit (GPU), and other specialized cores.

The processor 202 functions as the primary computational unit of the edge device 200. The processor 202 may be configured to execute all machine readable instructions required for OTA software update operations, local device coordination, and communication handling. The processor 202 may be implemented as a standalone CPU or as part of an integrated SoC that incorporates multiple specialized cores. In such configurations, the SoC may include a Graphics Processing Unit (GPU) for accelerated image or signal processing, digital signal processors for handling sensor data, and neural network or Artificial Intelligence (AI) acceleration engines that support decision making tasks such as selecting update sources, evaluating received beacon signals, or determining role transitions during distributed update propagation. The processor 202 orchestrates transmission and reception of beacon signals, evaluates received signal strength indicators, manages wireless network formation, authenticates proximate edge devices, and executes logic governing the master, slave, or intermediate update roles. The processor 202 also retrieves and stores update packages from memory 208, validates version information, and performs controlled installation sequences to prevent corruption or partial updates. In embodiments involving cloud interaction, the processor 202 manages secure communication sessions with the cloud server 105, polls for update availability, exchanges configuration parameters, and reports update progress or completion states. The processor 202 may additionally coordinate data from the sensor module 212, such as ignition state, motion state, or GPS positioning data, to determine whether network conditions and vehicle states are suitable for initiating OTA update discovery or short range communication. By integrating these capabilities, the processor 202 enables the edge device 200 to operate autonomously, adapt to changing network conditions, and reliably participate in distributed, proximity aware OTA software update workflows.

The communication module 204 enables the edge device 200 to establish reliable connectivity with the cloud server 105 and with nearby edge devices using multiple wired and wireless interfaces. The communication module 204 may support wide‑area communication technologies such as Long‑Term Evolution (LTE) for transmitting update‑related information, reporting device state, or downloading software packages directly from the cloud server 105 when network conditions allow. The communication module 204 may further include short‑range interfaces such as Bluetooth (BT), Bluetooth Low Energy (BT‑LE), Wireless Fidelity (Wi‑Fi), or Near‑Field Communication (NFC) to enable local communication between proximate edge devices for distributed OTA update transfer, beacon exchange, or peer‑to‑peer network formation. The communication module 204 may manage secure session establishment, encryption, and authentication for both cloud‑based and device‑to‑device interactions. The cloud server 105 may utilize information received through the communication module 204 to provide real‑time analytics assistance, update‑orchestration instructions, or dynamic configuration settings. In deployments involving cloud‑based coordination, the cloud server 105 may aggregate data received from multiple edge devices 200 for offline analysis, update scheduling, or performance assessment. The communication module 204 may also dynamically select a preferred communication interface based on signal strength, bandwidth availability, or vehicle state, allowing the edge device 200 to maintain consistent connectivity and efficient participation in OTA update workflows.

The I/O module 206 provides standardized electrical and logical interfaces that enable the edge device 200 to receive external signals and deliver output notifications or control responses. The I/O module 206 may include one or more hardware ports, digital interfaces, or communication pathways, such as general‑purpose input/output lines, serial interfaces, or vehicle‑specific signaling channels. The I/O module 206 may enable the edge device 200 to interact with one or more external components and receive and/or detect ignition signals, vehicle‑motion indicators, and other operational triggers generated by onboard systems. The I/O module 206 may also support output channels used to convey update prompts, system warnings, and status indications to a vehicle operator or supporting subsystem. In some embodiments, the I/O module 206 may incorporate interrupt‑driven circuitry or polling‑based detection logic that enables the processor 202 to react promptly to changes in vehicle state or operator interaction. Through these hardware and software interfaces, the I/O module 206 ensures that the edge device 200 maintains reliable, real‑time communication with vehicle systems and provides necessary outputs during OTA update procedures.

The memory 208 is communicatively coupled to the processor 202 and provides non‑transitory storage for data, instructions, and software components executed by the edge device 200. The memory 208 may include one or more volatile and non‑volatile storage technologies, such as random‑access memory, read‑only memory, electrically erasable memory, flash storage, or other computer‑readable media suitable for embedded systems. The memory 208 may store OTA update packages, beacon configurations, device identifiers, operating parameters, and version metadata used during distributed update procedures. The memory 208 may also maintain executable instructions that enable the processor 202 to perform beacon broadcasting, short‑range communication setup, association policies, update sequencing, and error‑handling routines. In some embodiments, the memory 208 includes cache structures that accelerate execution of instructions related to OTA update management or peer‑device coordination. The memory 208 may further include a database or structured storage region for retaining logs of update attempts, communication events, and historical version transitions. The functions performed by the memory 208 are independent of the underlying instruction set or storage medium and may be implemented through firmware, software, or hardware mechanisms operating alone or in combination. Through these capabilities, the memory 208 supports the processor 202 in managing update workflows, maintaining device state across power cycles, and enabling reliable participation in both cloud‑based and peer‑to‑peer OTA update processes.

The sensor module 212 may further include a Global Positioning System (GPS) receiver, either as a separate hardware component or built into the SoC. The sensor module 212 includes one or more sensing components that enable the edge device 200 to acquire vehicle‑state information, environmental cues, and operational parameters relevant to OTA update decisions. In a non‑limiting embodiment of the present disclosure, the sensor module 212 may include inertial measurement sensors such as accelerometers, gyroscopes, or magnetometers for detecting motion, vibration, or changes in vehicle dynamics. The sensor module 212 may further obtain diagnostic information from the On‑Board Diagnostics II (OBD‑II) interface, which may be accessed through a direct wired connection or through a Bluetooth (BT) link. This diagnostic information may include, but is not limited to, ignition status, engine parameters, battery condition, or other indicators used to determine suitable periods for initiating or deferring OTA update operations. In another non‑limiting embodiment, the sensor module 212 may include a Global Positioning System (GPS) receiver, either integrated within a SoC or implemented as a separate component, allowing the edge device 200 to identify geographic position, detect whether the associated vehicle is stationary, or determine fleet‑yard proximity during distributed update scenarios. The sensor module 212 may also gather environmental or contextual measurements, such as, but not limited to, temperature, cabin illumination, or short‑range signal quality, each of which may influence beacon broadcasting, peer selection, or connection stability. By continuously supplying the processor 202 with real‑time sensing information, the sensor module 212 enables the edge device 200 to accurately interpret operational context, adapt update behavior to varying vehicle conditions, and reliably engage in proximity‑based OTA update workflows.

The camera module 210 enables the edge device 200 to capture visual data using one or more imaging sensors, which may include, but are not limited to, a forward‑facing camera, a driver‑facing camera, or any external camera connected through a wired or wireless interface. The camera module 210 may provide image frames, video streams, or still photographs to the processor 202 for analysis, storage, or transmission to external systems, depending on the operational requirements of the edge device 200. The camera module 210 may include components such as an image sensor, optics, and signal‑processing circuitry, and may support functionalities such as exposure control, low‑light imaging, or digital stabilization. In some embodiments, the visual data acquired through the camera module 210 may assist the edge device 200 in context-aware tasks. For example, processing of visual data may confirm that the edge device 200 is in an environment, such as a parking area, depot, or yard, for which there is an elevated likelihood of stationary nearby edge devices. Similarly, processing of visual data may indicate that the edge device 200 is in an environment for which there is a reduced likelihood of stationary nearby edge devices, such as in on a road with free-flowing traffic.

Overall, FIG. 2 depicts the internal architecture of the edge device 200, showing how the processor 202, communication module 204, I/O module 206, memory 208, camera module 210, and sensor module 212 cooperate to support OTA update operations, cloud communication, and other vehicle‑related sensing and processing functions.

It will be understood that the components illustrated for the edge device 200 are merely exemplary and non‑limiting in nature. The edge device 200 may include additional hardware units, software modules, circuits, sensors, interfaces, or processing elements as required to support specific operational needs, and certain illustrated components may be omitted, combined, distributed, or implemented differently without departing from the scope of the present disclosure. The architecture shown in FIG. 2 therefore represents one non‑limiting embodiment, and any variation or extension of these components that performs substantially similar functions is considered to be within the scope of the edge device 200.

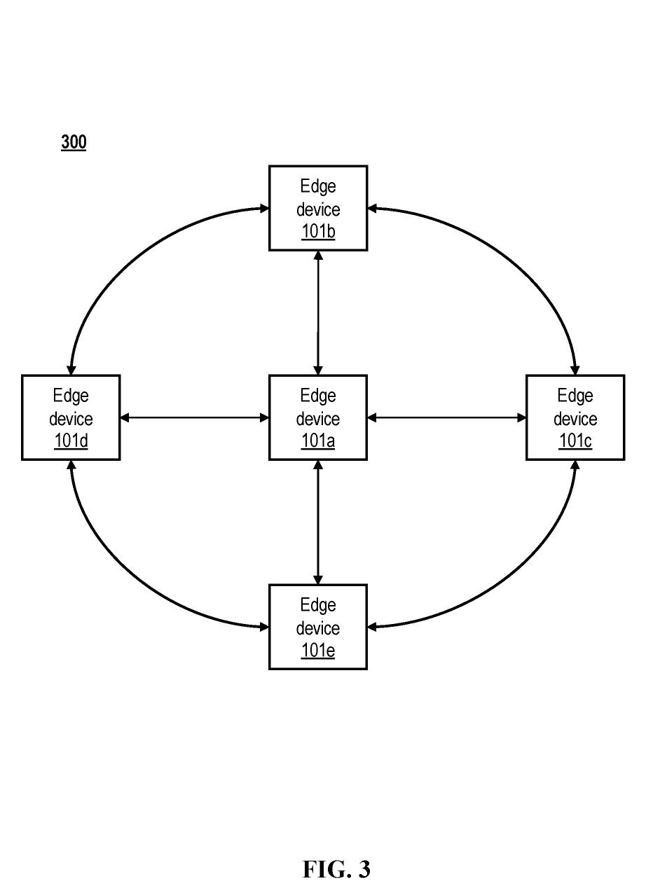

FIG. 3 illustrates an example environment 300 in which a group of edge devices forms a local ad hoc network for Over the Air (OTA) software update coordination. The environment 300 shows edge devices 101a, 101b, 101c, 101d, and 101e coupled by short range communication links indicated by the arrows. The edge device 101a is depicted at the center, with bidirectional links to edge devices 101b, 101c, 101d, and 101e. The curved outer connectors represent proximity based connectivity among the outer devices and indicate that peer to peer paths may be available in more than one direction.

In a non-limiting embodiment of the present disclosure, an edge device (for example, the central edge device 101a) may broadcast a beacon signal that includes, among other information, a software version indicator, a Service Set Identifier (SSID) for forming a local network, and a manufacturer identifier configured to ensure that only compatible or approved devices respond to and participate in the OTA update process. This manufacturer identifier may enable filtering of devices that belong to a particular fleet, product line, or hardware family, thereby preventing unintended association with unrelated devices in the vicinity. The edge devices 101b, 101c, 101d, and 101e respond to the received beacon signal with their version indicators and report Received Signal Strength Indicator (RSSI) measurements observed for the beacon of the corresponding edge device. Devices with a preceding version select a source device based on the next sequential version and strongest RSSI and then establish a short-range connection using Wi Fi, BT, BT LE, or NFC, as applicable.

The arrows in FIG. 3 denote logical communication paths rather than physical motion. Link direction is illustrative and may be bidirectional. Device count, placement, and link patterns shown are non-limiting and may vary based on radio conditions, proximity, and policy. Additional devices may join or leave the local ad hoc network without departing from the scope of the present disclosure.

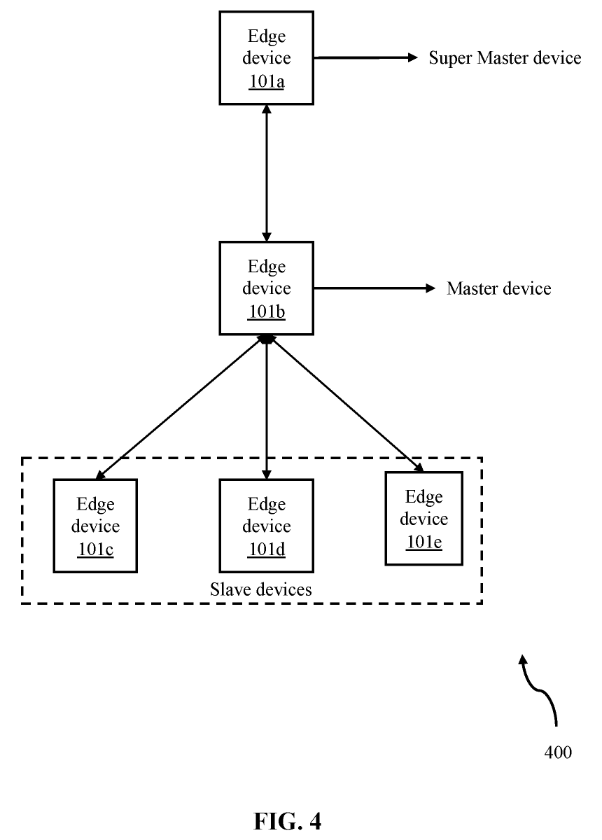

FIG. 4 illustrates an example hierarchy 400 for proximity‑based Over‑the‑Air (OTA) software update coordination among edge devices. As shown, the edge device 101a functions as a super master device, the edge device 101b functions as a master device, and the edge devices 101c, 101d, and 101e collectively function as slave devices. The arrows indicate logical update‑distribution paths and control signals exchanged during the sequence of operations. In some embodiments, the super master device 101a acts as a master node, the master device 101b acts as an intermediate node, and the slave devices 101c–101e act as slave nodes within the scope of the present disclosure.

In a non‑limiting embodiment of the present disclosure, the super master device 101a (the edge device 101a) initiates orchestration for a local update cycle. The edge device 101a may broadcast a beacon signal comprising a current version indicator and a Service Set Identifier (SSID) corresponding to a local wireless network to be established by the super master device 101a. The beacon may further include authentication metadata, a manufacturer identifier, and channel configuration data to constrain association to compatible devices and to manage contention. One or more proximate devices (for example the edge devices 101b-101e) respond with version indicators, enabling edge device 101a to determine whether lower‑version devices are present. Upon such determination, the edge device 101a may distribute orchestration parameters such as batch size, retry rules, and reporting cadence. In some embodiments, the first edge device 101a may establish a supervisory control link to the edge device 101b, receives progress events, and prioritizes downstream transmissions based on lowest reported versions and measured signal quality (e.g., RSSI), thereby enabling the “super master device” functions recited in the disclosure

In the hierarchy 400 of FIG. 4, the super master device 101a corresponds to the first edge device that initiates and supervises proximity-based OTA software update distribution within a vehicle-fleet cluster. The first edge device 101a begins a local cycle by broadcasting a beacon that carries its current software version indicator and the SSID for a wireless network to be established by the first edge device 101a. In a non-limiting embodiment of the present disclosure, the beacon further includes the authentication metadata, the manufacturer identifier, the network-capability indications, and the channel configuration data, thereby constraining association to compatible, authenticated fleet devices and tuning contention behavior for reliable short-range participation. The authentication metadata may refer to information used to verify that the broadcasting edge device is trusted and authorized. The authentication metadata may include cryptographic signatures, tokens, or secure credentials embedded within the beacon. The manufacturer identifier uniquely identifies the device’s maker, product line, or fleet group. The network capability indications describe the communication features supported by the broadcasting device. The channel configuration data provides wireless operating parameters, such as frequency, channel number, or timing values. Upon transmission of the beacon, proximate edge devices (for example, the edge devices 101b-101e) may respond with their respective software-version indicators. The first edge device 101a may evaluate the responses to identify the edge devices (for example, the edge device 101b) that carry a preceding version relative to its own version, and, when such lower-version responders are present, the first edge device 101a enables association and establishes a wireless network identified by the broadcast SSID. In one embodiment, the wireless network is configured as a Wireless Local Area Network (WLAN) led by the first edge device 101a, with admission policies derived from the beacon’s authentication fields and capability flags.

Following network formation, the first edge device 101a receives update requests from proximate edge devices that have selected 101a as their update source based on measured Received Signal Strength Indicator (RSSI) values and version sequencing rules. Selection is non-limiting and may prefer the next sequential version and the strongest RSSI to ensure stepwise progression and stable throughput. The first edge device 101a may transmit the software-update package through the established WLAN to each requesting device, optionally in verified segments that include integrity checks, signature validation, and controlled installation sequences to prevent partial or corrupted updates. Where multiple devices request updates concurrently, the first edge device 101a may prioritize transmission to a device reporting the lowest software version so that early upgrades create additional capable sources for cascading propagation. In a non-limiting embodiment, a hybrid scheduling function considers both lowest reported version and highest RSSI so that urgency and link quality jointly influence the order of delivery, accelerating overall cascade performance across the hierarchy.

Participation in the local cycle may be constrained to a predetermined proximity range relative to the first edge device 101a. The range can be derived from measured RSSI thresholds, depot geometry, or discovery filters embedded in the beacon, thereby keeping short-range dissemination reliable and minimizing interference with adjacent clusters. As association proceeds, the first edge device 101a may configure SSID broadcast rates, batch sizes, and admission windows based on the number of responses received. If many devices are eligible, the first edge device 101a can reduce broadcast frequency, partition devices into batches, and delegate subsets to a master or intermediate device; if few respond, the broadcast rate and association window may be extended to capture stragglers. Throughout delivery, the first edge device 101a monitors per-device update completion status, records a distribution log indicating device identifiers, pre-/post-version states, transfer timestamps, retries, error codes, segment-integrity results, and installation confirmations, and reports progress to higher-level orchestration where applicable. Logs may trigger topology reevaluation so that newly upgraded devices can assume appropriate roles and extend reach within the cluster.

In operation, the first edge device 101a provides supervisory control across multiple masters and their assigned slaves, issues orchestration parameters such as retry rules and reporting cadence, and maintains a control link for receiving progress events and enforcing prioritization. The WLAN created by the first edge device 101a and identified by its SSID provides the local transport required for short-range package delivery and control signaling, and may be terminated or reconfigured as role transitions occur. For example, after a master device has finished updating its assigned slaves, the master may terminate its local network and associate upward with the first edge device 101a to receive a next sequential version, then re-enter a master role to continue cascading distribution with enhanced capacity. By combining authenticated beacon discovery, SSID-based WLAN formation, RSSI-aware source selection, priority scheduling by version and signal strength, proximity constraints, adaptive broadcast and association policies, and detailed completion logging, the first edge device 101a enables orderly, secure, and efficient stepwise propagation of OTA software updates across proximate edge devices in the hierarchy of FIG. 4.

In the hierarchy 400 of FIG. 4, the edge device 101b operates as an intermediate node and may also be referred to as the third edge device 101b. The third edge device 101b participates in cascading Over‑the‑Air (OTA) software update distribution by alternately assuming a master role phase to serve lower‑version proximate devices (for example, the edge devices 101c-101e) and a slave role phase to receive the next sequential version from a higher‑version device (for example, the edge device 101a). This dual‑phase behavior enables orderly, stepwise propagation of updates across proximate devices while maintaining controlled association and reliable throughput.

The third edge device 101b may detect beacon signals transmitted by the one or more proximate edge devices. Each beacon includes a software‑version indicator and a Service Set Identifier (SSID) of an available wireless network. Upon detection, the third edge device 101b determines a set of first proximate devices that carry a higher software version (e.g., including the first edge device 101a) and a set of second proximate devices that carry a lower software version (e.g., the edge devices 101c–101e). The third edge device 101b then evaluates a distribution topology that accounts for a count of second proximate devices, communication range, measured RSSI values, and version‑gap magnitudes among detected devices. In a non‑limiting embodiment of the present disclosure, the third edge device 101b may compute a weighted score that combines version‑gap magnitude with RSSI measurements to one or more first proximate devices, thereby guiding role selection, broadcast parameters, and target selection for subsequent association.

When conditions favor serving lower‑version devices, the third edge device 101b initiates a master role phase. During this phase, the third edge device 101b broadcasts a beacon that includes its current version indicator and an SSID identifying a wireless network to be created by the third edge device 101b. The beacon may additionally carry authentication metadata, manufacturer identifier, network‑capability indications, and channel configuration data to facilitate controlled association. The lower‑version devices (e.g., any of the edge devices 101c–101e) may establish the wireless network by associating with the third edge device 101b using the broadcast SSID. Once associated, third edge device 101b transmits a software update package to each connected second proximate device. Delivery may occur in verified segments with integrity checks and installation confirmations to ensure reliable progression from the current version to the next sequential version.

While serving as a master, the third edge device 101b monitors update completion status for each connected second proximate device and logs per‑device completion events in a distribution record. The log may include device identifiers, pre‑/post‑version states, transfer timestamps, retries, error codes, and installation confirmations. These records support audit, orchestration, and subsequent topology reevaluation. After completing the master role phase for its assigned set of second proximate devices, the third edge device 101b terminates the established wireless network to release spectrum resources and avoid association conflicts during upward progression.

The third edge device 101b then transitions to a slave role phase. In this phase, the third edge device 101b may detect beacon signals from the one or more first proximate devices with higher software versions (e.g., the edge device 101a). Based on measured RSSI, the third edge device 101b selects a target master device among the first proximate devices and establishes a connection to the wireless network identified by that target’s SSID. The third edge device 101b receives a software update package from the selected target master device and installs the software update package to upgrade to the next sequential version. In some embodiments, installation of the software update package may include pre‑checks, staged write operations, and rollback safeguards to prevent partial or corrupted updates.

Upon successful completion of the slave role phase, the third edge device 101b may re-evaluate the network topology. The processor 202 updates its knowledge of version states, RSSI conditions, proximity counts, and device loads, and determines whether additional second proximate devices require updates. If further lower‑version devices are available within suitable range or newly reachable due to changed conditions, the third edge device 101b repeats the master role phase with enhanced capacity corresponding to its newly installed version.

Selection and scheduling in both phases may prioritize devices with lowest software versions and highest RSSI, or employ the weighted score noted above to balance urgency (version gap) and link quality (RSSI). The beacon broadcast by the third edge device 101b includes the SSID corresponding to the wireless network to be established by the third edge device 101b, and, prior to entering the slave role phase, the third edge device 101b terminates any previously established wireless network to ensure clean hand‑off and to comply with association policy. Through these operations, the third edge device 101b implements the full intermediate‑node behavior for cascading OTA updates i.e., detecting beacon signals, determining higher‑ and lower‑version sets, evaluating topology, initiating and serving a master role phase, monitoring and logging completions, transitioning to a slave role phase, selecting a target master by RSSI, upgrading to the next sequential version, and repeating the cycle with improved distribution capacity.

An illustrative, non‑limiting example clarifies the flow of the present disclosure. Suppose the first edge device 101a has version V3, the edge device 101b has V2, and the slave devices 101c–101e have V1. The super master 101a discovers the edge devices 101b–101e, assigns 101b to update the slave devices 101c–101e, and supervises reporting. The edge device 101b forms a local WLAN, authenticates 101c–101e, and transmits the V2 update package. Each slave device 101c-101e installs V2 and reports completion to the edge device 101b, which logs status and notifies the edge device 101a. The master 101b then terminates its WLAN, enters its slave role, and associates upward with the edge device 101a to receive V3. After installing V3, the edge device 101b re‑evaluates topology. If any additional V1 devices are now within range, the edge device 101b re‑enters a master role to disseminate V2 or V3 as appropriate. Throughout, tie‑break rules, RSSI‑based source selection, and authentication constraints ensure that updates cascade predictably and securely.

In a non‑limiting example, after the edge device 101b upgrades from V2 to V3, its broadcast may attract additional V1/V2 devices not previously reachable or eligible; the edge device 101b forms a new network using its SSID and transmits update packages to those devices, thereby continuing the cascade.

In the hierarchy 400 of FIG. 4, the edge devices 101c, 101d, and 101e correspond to second edge devices that operate as slave nodes during proximity‑based the OTA software update distribution. Each slave device detects one or more beacon signals transmitted by proximate edge devices. In a non‑limiting embodiment of the present disclosure, each beacon includes a software‑version indicator and a SSID identifying an available wireless network. Upon receiving these beacons, the slave device evaluates the embedded version metadata to determine whether it possesses the lowest software version among the detected devices and thereby qualifies for stepwise upgrading relative to devices advertising higher versions.

After confirming its relative version state, the slave device measures RSSI values for the beacons detected from proximate devices. Using the measured RSSI and version metadata, the slave device selects a target master device that advertises the next sequential version relative to its current version and that exhibits the strongest RSSI among devices with that next sequential version. Selection logic may, in a non‑limiting embodiment, apply a tie‑break rule based on beacon age or reported device load to avoid congested sources or stale discovery data.

Once the target master is selected, the slave device establishes a connection to the wireless network identified by the target’s SSID, receives a software update package corresponding to the next sequential version, and installs the package to transition from its current version to the next sequential version. Installation may include integrity checks, staged writes, and rollback safeguards to prevent partial updates. If the download fails or the link quality degrades, the slave device may retry association with an alternative master device, repeating selection and connection steps until a reliable transfer is achieved.

By operating in this manner, the slave devices 101c–101e implement the full slave‑node behavior for cascading OTA updates i.e., detecting compatible beacons, determining lowest‑version status via embedded version metadata, measuring RSSI, selecting a next‑sequential‑version master based on strongest RSSI (with tie‑breaks where applicable), associating to the master’s SSID, receiving and installing the update package, and retrying with alternative masters when necessary, thereby enabling orderly, incremental progression of versions across the hierarchy.

The arrangement shown in FIG. 4 is non‑limiting and may vary by device counts, placement, radio conditions, and policy. Roles may be reassigned dynamically. For example, another device may be designated as super master based on processing capability or connectivity, and additional devices may join or leave without departing from the scope of the present disclosure.

In one embodiment, edge devices in proximity may broadcast BT signals to discover and connect with other edge devices and to form a local network. Each edge device can scan for nearby BT beacons, detect basic identification information, and compile a list of discovered devices within range. After discovery, devices may exchange pairing requests, authenticate, and establish secure BT connections that enable formation of a local ad hoc network suitable for update coordination.

In another embodiment, the edge device 101a forms a local area network using Wireless Fidelity (Wi Fi) hotspot tethering. The edge device 101a may belong to a fleet of similar edge devices 101 installed in vehicles and sharing comparable hardware and software. To use the hotspot of another edge device, the edge device 101a may first confirm proximity to other devices and may wait until the associated vehicle is stationary. The edge device 101a may monitor vehicle state signals and determine that the vehicle has remained stationary for longer than a threshold period. The edge device 101a may trigger beacon broadcasting upon detecting that the ignition is turned off, since this indicates the device will likely remain stationary long enough to negotiate connections and form the local area network.

In a non-limiting embodiment, once the ignition off condition is detected, the edge device 101a may broadcast a beacon signal configured to seek responses from compatible devices, such as devices of the same manufacturer or fleet. The beacon may be sent using a BT communication module or any suitable NFC module. The beacon may include a Unique Identifier (UID) associated with a specific manufacturer or set of fleet devices. The UID helps map the edge device to an external record and may have two parts, where the first part groups a set of beacons and the second part identifies individual devices in that group. The beacon may also include a broadcast protocol understood by desired devices, including data formats, encryption standards, or communication norms tailored to the manufacturer’s ecosystem.

In some embodiments, the surrounding edge devices 101b, 101c, 101d, and 101e recognize the beacon from the edge device 101a based on the UID. The devices 101a to 101e may implement a near field protocol for proximity messaging. As a non-limiting example, the protocol may follow the Eddystone specification that defines a BT LE message format for proximity beacons. The beacon may carry a data field such as a UID that indicates the type of devices allowed to respond. In one scenario, the UID is recognized by devices in the same fleet. In another scenario, the UID is recognized by devices of the same model or manufacturer.

In an embodiment, a group of intermediate edge devices 101b, 101c, 101d, and 101e may respond with their detection messages. The edge devices 101a to 101e may receive beacons originating from other devices and identify the UID values that mark fleet membership, sub group membership, device model, manufacturer, operating system version, or similar attributes. The UID can be unique to the group type in entirety or partially unique in a specific segment. After successful responses and authentication, the devices 101a to 101e may connect and form the local area network.

In one embodiment, when vehicles equipped with edge devices enter proximity such as in the same yard or parking lot, each edge device may continuously send BT beacons that announce their presence. Other devices within range detect these beacons, maintain a list of discovered neighbors, and proceed to pairing and authentication. Upon pairing, the devices form a secure BT connection. After forming the local ad hoc network, devices exchange identification data such as unique IDs and BT signal strength values. Devices perform link stability checks and, if any links are unstable, they reconnect or adjust parameters to stabilize the ad hoc network.

In another embodiment, the cloud server 105 detects that a group of edge devices are co located. The cloud server 105 instructs these devices to switch on BT modes and to form the local ad hoc network when some devices in the group are not up to date. This enables a guided local update process that reduces wide area bandwidth usage.

In one embodiment, the edge devices 101a to 101e exchange their software version information after confirming network stability. The edge devices 101a-101e may also share BT signal strength values. Each device compiles a list of all versions present in the ad hoc network and compares its own version against the others. An edge device with the newest version assigns itself the role of master. An edge device with an older version assigns itself the role of slave. If there are multiple masters, one edge device assigns itself the role of super master. As a non-limiting example, the master with the strongest BT signal or with the highest processing capability becomes the super master. The selected super master sends a confirmation signal to all connected devices indicating its role.

In an embodiment, once roles are assigned and the network is stable, the super master device sets up a Wi Fi hotspot. The slave devices connect to the Wi-Fi hotspot to receive update data at higher throughput compared with BT. In some embodiments, the super master device serves as the primary coordinator and controller for discovery, role assignment, and batch scheduling. The super master oversees software version discovery, maps dependencies, and establishes an incremental upgrade path so that all devices progress to the latest version in a controlled manner. The super master manages update distribution by sending the required files to master devices, which then pass them to slave devices, thereby reducing load on any single device.

In one embodiment, the super master monitors update progress across the network, tracks installations, identifies failures, and triggers retries or logs issues for later intervention. The super master enforces protocol compliance, sends control signals and instructions to the master and slave devices, and maintains detailed logs of successes, errors, and retries. At completion, the super master coordinates disbandment. Devices disconnect from the local BT or Wi Fi network and return to their default communication modes such as Long Term Evolution (LTE). The super master may maintain readiness for subsequent cycles so the update process can repeat efficiently as new versions become available.

In some embodiments, a master device acts as a critical intermediary within the local network. The super master assigns each master device a subset of slaves based on processing capability and other metrics. The master device updates its assigned slaves to its own version and ensures correct receipt, validation, and installation. The master device may defer its own upgrade until all assigned slaves reach the master’s version, thereby keeping the cascade orderly. After slaves reach the master’s version level, the super master upgrades masters in batches so the entire network eventually synchronizes to the latest version.

In some embodiments, a slave device with an older version establishes a communication link to its assigned master, validates the integrity of the received update package, and installs the update without disrupting ongoing operations. The slave provides status feedback to the assigned master and confirms successful installation. This feedback enables effective management and ensures that all slaves reach the desired version level. After updates complete, masters verify slave status, compile a report with pre and post versions and resolutions of any issues, and send the report to the super master. The super master aggregates reports into a comprehensive network summary, including update timelines, device statuses, error resolutions, and final version distribution. Once verified, the super master concludes the cycle and gracefully disbands the temporary hierarchy. Devices revert to standard communication protocols and normal operation. Post update monitoring may be performed to verify correct functioning and to address any residual issues so that network stability is maintained.

The foregoing embodiments collectively describe discovery, proximity controlled local network formation, role assignment, hotspot based high throughput update transfer, supervised cascade rollout, logging, and graceful disbandment. Certain aspects may already be covered in prior sections. In some embodiments the described steps are adapted or reordered to match fleet conditions or policy requirements. In some other embodiments additional sensors, communication interfaces, or orchestration rules are employed without departing from the scope of the present disclosure.

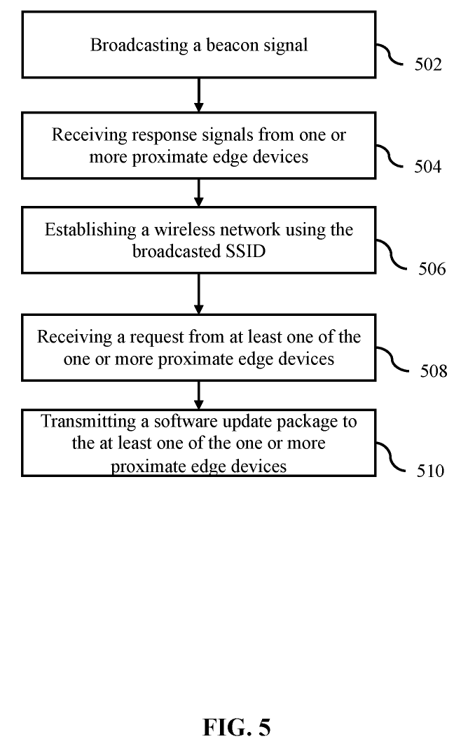

FIG. 5 illustrates a flowchart of a method 500 for distributing software updates an edge device functioning as a master node, in a vehicle fleet network, in accordance with an embodiment of the present disclosure. The method 500 includes a series of operation steps 502 through 510 performed by the processor 202 of the first edge device 101a.

At step 502, the method 500 includes broadcasting, by the first edge device 101a, a beacon signal. The beacon signal includes a current software version indicator of the first edge device 101a and a SSID corresponding to a wireless network to be established by the first edge device 101a. In some embodiments, the beacon signal may further include authentication metadata or network‑capability information to facilitate controlled association among proximate devices. In one embodiment, the first edge device 101a may broadcast the beacon signal when the first edge device 101a recognizes that it has the latest software version upon communicating with cloud server 105. The first edge device 101a may also broadcast the beacon signal if it has recently received updates from the cloud server 105, in this case the beacon signal is broadcasted by the first edge device 101a upon completing the update process by the cloud server 105.

At step 504, the method 500 includes receiving, by the first edge device 101a, one or more response signals transmitted by proximate edge devices 101b–101e. Each response signal may include a software version indicator of the corresponding proximate edge device, enabling the first edge device 101a to evaluate version differences within the local proximity group.

At step 506, the method 500 includes establishing, by the first edge device 101a, a wireless network using the broadcasted SSID. The wireless network is established upon determining that at least one responding proximate edge device (e.g., the edge devices 101b, 101c) possesses a preceding software version relative to the version of the first edge device 101a, as indicated by the received software version indicators.

At step 508, the method 500 includes receiving, by the first edge device 101a, a request signal from at least one proximate edge device. The requesting proximate device selects the first edge device 101a as an update source based on measured RSSI values, which indicate the quality of the short‑range communication link.

At step 510, the method 500 includes transmitting, by the first edge device 101a through the established wireless network, a software update package to the at least one requesting proximate edge device (e.g., edge device 101b). The transmission may include verified segments, integrity checks, or controlled sequencing to ensure successful version transition at the receiving device.

The various actions, acts, blocks, or steps in the flowchart may be performed in the order presented, in a different order, or simultaneously. In some embodiments, certain steps may be omitted, added, modified, or skipped without departing from the scope of the present disclosure.

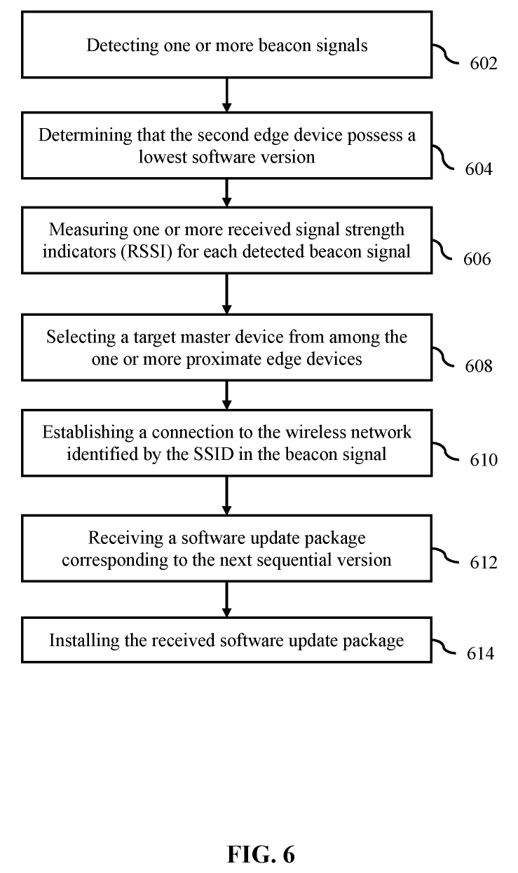

FIG. 6 illustrates a flowchart of a method 600 for receiving software updates by an edge device functioning as a slave node in a vehicle fleet network, in accordance with an embodiment of the present disclosure. The method 600 includes a series of operation steps 602 through 614 performed by the processor 202 of a second edge device, such as the edge device 101c.

At step 602, the method 600 includes detecting, by the second edge device 101c, one or more beacon signals broadcast by proximate edge devices, such as the edge devices 101a or 101b. Each beacon signal includes the software version indicator and the SSID corresponding to an available wireless network.

At step 604, the method 600 includes determining, by the second edge device 101c, that it possesses the lowest software version among the detected proximate edge devices, based on the software version indicators included within the received beacon signals.

At step 606, the method 600 includes measuring, by the second edge device 101c, one or more RSSI values for each detected beacon signal to evaluate the link quality to each proximate device.

At step 608, the method 600 includes selecting, by the second edge device 101c, a target master device, such as the edge device 101b, from among the proximate edge devices. The selected target master device possesses a next sequential software version relative to the current version of the second edge device 101c and exhibits the strongest RSSI value among devices advertising the next sequential version.

At step 610, the method 600 includes establishing, by the second edge device 101c, a connection to the wireless network identified by the SSID provided in the beacon signal of the selected target master device. In one embodiment, the second edge device 101c may be configured to derive password from the SSID, for the connection to the wireless network

At step 612, the method 600 includes receiving, by the second edge device 101c, a software update package corresponding to the next sequential version through the established wireless connection.

At step 614, the method 600 includes installing, by the second edge device 101c the received update package to transition from its current software version to the next sequential version.

The various actions, acts, steps, or operations in the flowchart may be performed in the order shown, in a different order, or simultaneously. In some embodiments, certain steps may be added, omitted, modified, or skipped without departing from the scope of the present disclosure.

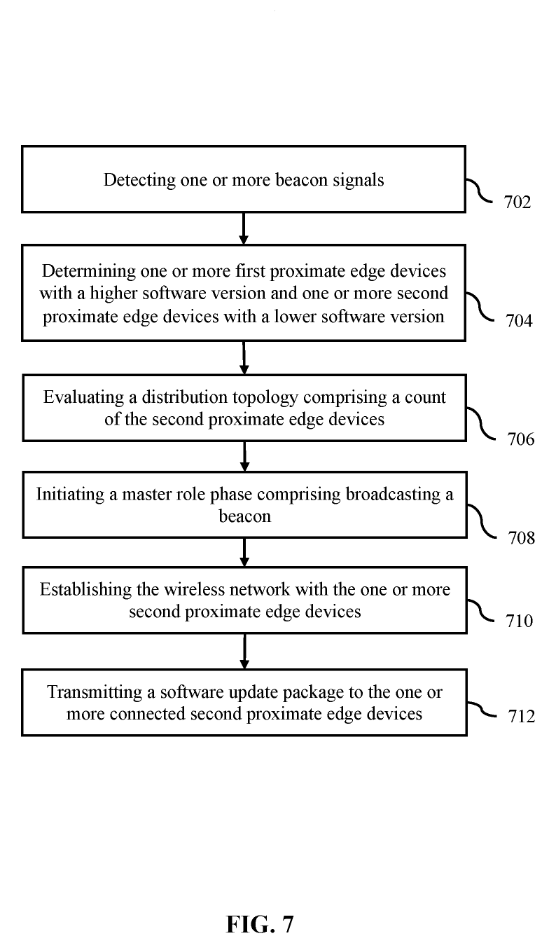

FIG. 7 illustrates a flowchart of a method for cascading software updates by an edge device functioning as an intermediate node in a vehicle fleet network, in accordance with an embodiment of the present disclosure. The method 700 includes a series of operation steps 702 through 712 performed by the processor 202 of a third edge device, such as the edge device 101b.

At step 702, the method 700 includes detecting, by the third edge device 101b, one or more beacon signals transmitted by proximate edge devices, such as the edge devices 101a, 101c, 101d, or 101e. Each beacon signal includes the software version indicator and the SSID corresponding to a wireless network available for association.

At step 704, the method 700 includes determining, by the third edge device 101b, a set of first proximate edge devices that possess a higher software version than the version of the third edge device 101b, and a set of second proximate edge devices that possess a lower software version than the version of the third edge device 101b, based on the software version indicators obtained from the detected beacon signals.

At step 706, the method 700 includes evaluating, by the third edge device 101b, a distribution topology. The evaluation is based at least on (i) a count of the second proximate edge devices, (ii) a communication range, (iii) measured Received Signal Strength Indicator (RSSI) values, and (iv) differences between the detected software versions. This evaluation enables the third edge device 101b to determine whether to act in a master role for update dissemination.

At step 708, the method 700 includes initiating a master role phase by the third edge device 101b. During this phase, the third edge device 101b broadcasts a beacon signal that includes an SSID corresponding to a wireless network to be created by the third edge device itself, thereby enabling lower‑version devices to identify it as a valid update source.

At step 710, the method 700 includes establishing the wireless network between the third edge device 101b and the one or more second proximate edge devices that possess lower software versions. These lower‑version devices may associate with the third edge device 101b using the SSID included in the broadcast beacon signal.

At step 712, the method 700 includes transmitting, by the third edge device 101b, a software update package to the one or more connected second proximate edge devices. This transmission enables the lower‑version devices to upgrade to their next sequential software version as part of a cascading update sequence.

The various actions, acts, blocks, or steps illustrated in FIG. 7 may be performed in the order shown, in a different order, or simultaneously. In some embodiments, certain actions may be added, omitted, modified, or rearranged without departing from the scope of the present disclosure.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more specialized processors for implementing the neural networks, for example, as well as for other processing systems described herein.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for distributing software updates by an edge device functioning as a master node, in a vehicle fleet network, the method comprising:
broadcasting, by a first edge device, a beacon signal comprising a current software version indicator of the first edge device and a service set identifier (SSID) corresponding to a wireless network to be established by the first edge device;
receiving, by the first edge device, response signals from one or more proximate edge devices, wherein each response signal comprises a software version indicator of the responding proximate edge device;
establishing, by the first edge device, a wireless network using the broadcasted SSID upon determining that one or more responding proximate edge devices possess a software version preceding a software version of the first edge device as indicated by corresponding software version indicators;
receiving, by the first edge device, a request from at least one of the one or more proximate edge devices that have selected the first edge device as an update source based on received signal strength indicator (RSSI) measurements; and
transmitting, by the first edge device through the established wireless network, a software update package to the at least one of the one or more proximate edge devices.

2. The method of claim 1, wherein transmitting the software update package comprises:
transmitting the software package on priority to a proximate edge device having lower software version than another proximate edge device to facilitate cascading update propagation.

3. The method of claim 1, wherein each of the one or more proximate edge devices locates within a predetermined proximity range of the first edge device.

4. The method of claim 1, wherein the beacon signal further includes authentication metadata, a network capability indication, or channel configuration data for facilitating controlled association.

5. The method of claim 1, wherein establishing the wireless local area network comprises configuring a SSID broadcast rate and association policies based on a number of the response signals received from the one or more proximate edge devices.

6. The method of claim 1, wherein transmitting the software update package comprises:
prioritizing transmissions of the software update package based on a combination of lowest software versions and a highest RSSI to accelerate cascade throughput.

7. The method of claim 1, further comprising:
monitoring update completion status of each connected proximate edge device; and
in response to monitoring, recording a distribution log indicative of the update completion status of the each connected proximate edge device.

8. The method of claim 1, wherein the wireless network is configured as a Wireless Local Area Network (WLAN) identified by the SSID created by the first edge device.

9. A method for receiving software updates by an edge device functioning as a slave node in a vehicle fleet network, the method comprising:
detecting, by a second edge device, one or more beacon signals from one or more proximate edge devices, wherein each beacon signal comprises a software version indicator and a Service Set Identifier (SSID) of an available wireless network;
determining, by the second edge device, that the second edge device possess a lowest software version among the one or more proximate edge devices;
measuring, by the second edge device, one or more received signal strength indicators (RSSI) for each detected beacon signal;
selecting, by the second edge device, a target master device from among the one or more proximate edge devices, the target master device possess a next sequential software version relative to a current software version of the second edge device and exhibiting a strongest RSSI value among the one or more proximate edge devices possessing the next sequential version;
establishing, by the second edge device, a connection to the wireless network identified by the SSID in the beacon signal of the target master device;
receiving, by the second edge device through the wireless network connection, a software update package corresponding to the next sequential version; and
installing, by the second edge device, the received software update package to transition from the current software version to the next sequential version.

10. The method of claim 9, wherein selecting the target master device from among the one or more proximate edge devices further comprises applying a tie break rule based on an age of the detected one or more beacons or corresponding proximate edge device load.

11. The method of claim 9, wherein the second edge device retries association with an alternative master device upon detecting a failed download or a degraded link quality.

12. The method of claim 9, wherein determining the lowest software version includes evaluating version metadata embedded in the beacon signal.

13. A method for cascading software updates by an edge device functioning as an intermediate node in a vehicle fleet network, the method comprising:
detecting, by a third edge device, one or more beacon signals from one or more proximate edge devices, wherein each beacon signal comprises a software version indicator and a Service Set Identifier (SSID) of an available wireless network;
determining, by the third edge device, one or more first proximate edge devices with a higher software version and one or more second proximate edge devices with a lower software version among the one or more proximate edge devices;
evaluating, by the third edge device, a distribution topology comprising a count of the second proximate edge devices, based at least on a communication range, received signal strength indicators (RSSI) measurements, and a difference in software versions between detected software versions;
initiating, by the third edge device, a master role phase comprising broadcasting a beacon signal including an SSID for a wireless network to be created by the third edge device;
establishing the wireless network with the one or more second proximate edge devices; and
transmitting a software update package to the one or more connected second proximate edge devices.

14. The method of claim 13, further comprising:
monitoring update completion status for each of the one or more connected second proximate edge devices;
upon completion of the master role phase, transitioning, by the third edge device, to a slave role phase comprising terminating the established wireless network, detecting beacon signals from the one or more first proximate edge devices;
selecting a target master proximate edge device among the one or more first proximate edge device based on RSSI measurements;
establishing a connection with the target master proximate edge device;
receiving, from the target master proximate edge device, a software update package;
installing the received software update package to upgrade to a next sequential version;
upon successful completion of the slave role phase, re-evaluating, by the third edge device, the network topology to determine availability of additional one or more second proximate edge devices requiring updates; and
repeating the master role phase with enhanced update distribution capacity corresponding to a newly installed software version.

15. The method of claim 13, wherein evaluating the distribution topology comprises computing a weighted score based on version gap magnitude and measured RSSI to the one or more first proximate edge devices.

16. The method of claim 13, wherein selecting the target master proximate edge device during the slave role phase is based on RSSI measurements.

17. The method of claim 13, wherein the third edge device monitors update completion during the master role phase and logs per-device completion events.

18. The method of claim 13, wherein the beacon signal broadcasted by the third edge device includes the SSID corresponding to the wireless network to be established by the third edge device.

19. The method of claim 13, wherein prior to entering the slave role phase, the method comprises:
terminating the previously established wireless network.
